(19) United States
(12) Patent Application Publication
(10) Pub. No.: US 2003/0040215 A1
(43) Pub. Date: Feb. 27, 2003

(54) Insulated flexible adjustable busbar

(76) Inventor: Randall J. Kleen, Houston, TX (US)

Correspondence Address: Kevin T. Duncan, Esq., Hunton & Williams, Suite 1200, 1900 K Street, NW, Washington, DC, 20006-1109, US

(21) Appl. No.: 09/935,680

(22) Filed: Aug. 24, 2001

(51) Int. Cl. H01R 31/08

(52) U.S. Cl. 439/510

(57) ABSTRACT

A flexible electrical connector is provided for connecting a connection point of a first piece of electrical equipment to a connection point of a second piece of electrical equipment. The connector has a first connection end, a second connection end, a flexible portion having first and second ends, the first end being electrically and mechanically connected to the first connection end and the second end being electrically and mechanically connected to the second connection end, and an insulating sleeve. When the connector is in use, the insulating sleeve covers the flexible portion and the first and second connection ends. The first connection end is adapted to connect to the connection point of the first piece of electrical equipment and the second connection end is adapted to connect to the connection point of the second piece of electrical equipment. The second connection end is attachable in a plurality of fixing positions relative to the connection point of the second piece of electrical equipment so as to accommodate a plurality of distances between the first piece of electrical equipment and the second piece of electrical equipment.

### BACKGROUND OF THE INVENTION

Embodiments of the invention relate to connectors for electrical equipment. More particularly, embodiments of the invention relate to insulated flexible connectors for electrical equipment.

Large electrical equipment, for example a generator set, is often manufactured in various pieces or cubicles. The pieces or cubicles are then often assembled at the location where the equipment will be used. This assembly outside of the manufacturing facility introduces the possibility of varying distances between pieces or cubicles of the equipment that must be electrically connected to each other.

One method of electrically connecting the various pieces or cubicles of the equipment is to measure the exact length of connectors needed after the equipment is installed.

### SUMMARY OF THE INVENTION

The invention provides, among other things, solutions to problems associated with assembling pieces of equipment outside of the manufacturing facility.

Particular embodiments of the invention include a flexible electrical connector for connecting a connection point of a first piece of electrical equipment to a connection point of a second piece of electrical equipment. The connector has a first connection end, a second connection end, a flexible portion having first and second ends, the first end being electrically and mechanically connected to the first connection end and the second end being electrically and mechanically connected to the second connection end, and an insulating sleeve. When the connector is in use, the insulating sleeve covers the flexible portion and the first and second connection ends. The first connection end is adapted to connect to the connection point of the first piece of electrical equipment and the second connection end is adapted to connect to the connection point of the second piece of electrical equipment. The second connection end is attachable in a plurality of fixing positions relative to the connection point of the second piece of electrical equipment so as to accommodate a plurality of distances between the first piece of electrical equipment and the second piece of electrical equipment.

Particular embodiments of the invention include a method of connecting a connection point of a first piece of electrical equipment to a connection point of a second piece of electrical equipment using a flexible electrical connector. The flexible electrical connector has a flexible portion with first and second ends, a first connection end is attached to the first end and a second connection end is attached to the second end. The first connection end is connected to the connection point of the first piece of electrical equipment. An insulating sleeve is slid over the second connection end, the flexible portion and the first connection end, such that a portion of the second connection end is accessible for connecting to the connection point of the second piece of electrical equipment. The second connection end is connected to the connection point of the second piece of electrical equipment. The insulating sleeve is slid over the second connection end, such that the insulating sleeve covers the first connection end, the flexible portion and the second connection end. The insulating sleeve is fixed so that it covers the first connection end, the flexible portion and the second connection end during use of the flexible electrical connector. The second connection end is attachable in a plurality of fixing positions relative to the connection point of the second piece of electrical equipment so as to accommodate a plurality of distances between the first piece of electrical equipment and the second piece of electrical equipment.

Particular embodiments of the invention include an electrical equipment assembly. The electrical equipment assembly includes a first piece of electrical equipment having an electrical connection point, a second piece of electrical equipment having an electrical connection point, and a flexible electrical connector for connecting the connection point of the first piece of electrical equipment to the connection point of the second piece of electrical equipment. The connector has a first connection end, a second connection end, a flexible portion having first and second ends, the first end being electrically and mechanically connected to the first connection end and the second end being electrically and mechanically connected to the second connection end, and an insulating sleeve. When the connector is in use, the insulating sleeve covers the flexible portion and the first and second connection ends. The first connection end is connected to the connection point of the first piece of electrical equipment and the second connection end is connected to the connection point of the second piece of electrical equipment. The second connection end is attachable in a plurality of fixing positions relative to the connection point of the second piece of electrical equipment so as to accommodate a plurality of distances between the first piece of electrical equipment and the second piece of electrical equipment.

These and other features of the invention will be readily apparent to those skilled in the art upon reading this disclosure in connection with the attached drawing figures.

### BRIEF DESCRIPTION OF THE DRAWINGS

FIG. 1 is a schematic view of electrical equipment that can be connected by embodiments of the invention;

FIG. 2 is a side view of a busbar in accordance with the invention;

FIG. 3 is a said view of a busbar partially installed between two pieces of electrical equipment;

FIG. 4 is a side view of a busbar and insulation partially installed;

FIG. 5 is a side view of a busbar and insulation partially installed;

FIG. 6 is a side view of a busbar and insulation partially installed;

FIG. 7 is a cut-away view of a busbar and insulation partially installed; and

FIG. 8 is a side view of an installed busbar and insulation in accordance with embodiments of the invention.

### DETAILED DESCRIPTION OF THE INVENTION

When large scale electrical equipment is installed in various pieces or cubicles, it is often difficult to determine the exact length of electrical connectors needed to connect the various pieces or cubicles to each other or to existing equipment. One method of connecting such equipment is to take measurements after the equipment is installed to determine the exact length of connectors needed. However, this method is inefficient and can delay installation because the required electrical connectors can take a significant period of time to fabricate.

In addition, a corona discharge effect to surrounding equipment can be created by the one or more electrical connectors needed to connect the electrical equipment. The magnitude of the corona discharge effect can vary with the size and position of the electrical connector used. As a result, the invention provides electrical insulation of the connector.

In order to avoid the inefficiencies and delays caused by field measurement of the equipment, the invention provides a flexible, adjustable electrical connector for connecting the various pieces of electrical equipment.

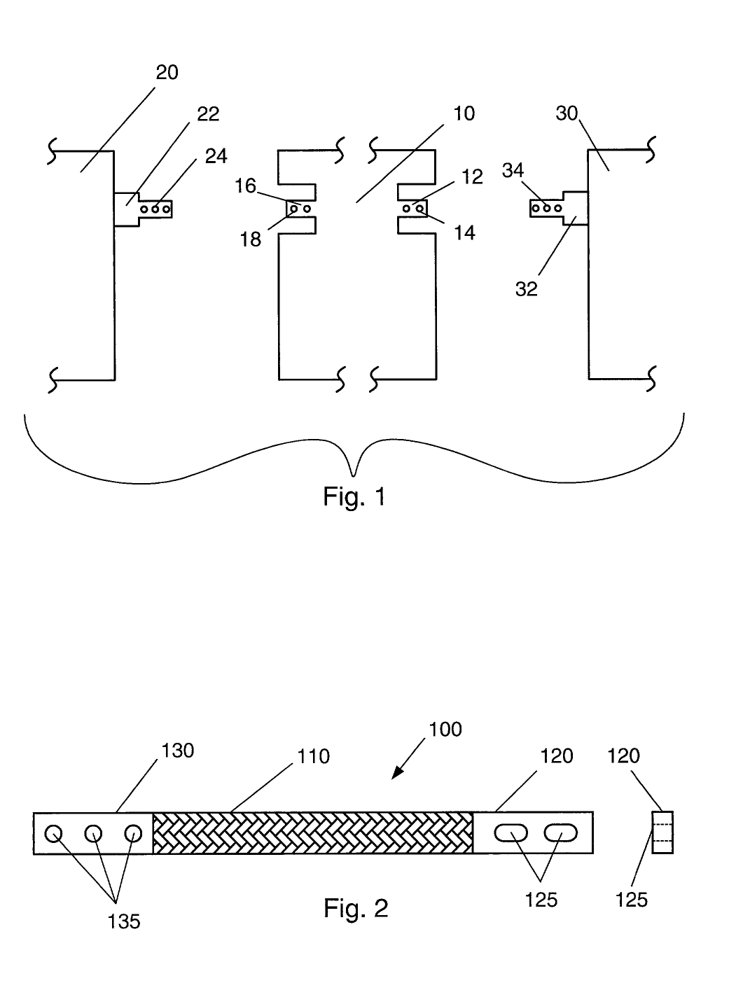

FIG. 1 shows a first piece of electrical equipment 10 having a connection point 12 with connection holes 14 and a connection point 16 with connection holes 18. Although two connection points, 12, 16, are shown in FIG. 1, it is understood that first piece of electrical equipment 10 can have any number of connection points suitable for the particular installation. It is further noted that first piece of electrical equipment 10 can often have eight or more such connection points. First piece of electrical equipment 10 can be various types of electrical equipment such as, for example, an electrical generator. FIG. 1 also shows a second piece of electrical equipment 20 having a connection point 22 with connection holes 24 and a third piece of electrical equipment 30 having a connection point 32 with connection holes 34. Second piece of electrical equipment 20 and third piece of electrical equipment 30 can be various types of electrical equipment such as, for example, a neutral cubicle or a switch-gear cubicle.

It is noted that the shape and number of connection points and connection holes in FIG. 1 are for example only and that any suitable shape and/or number can be used.

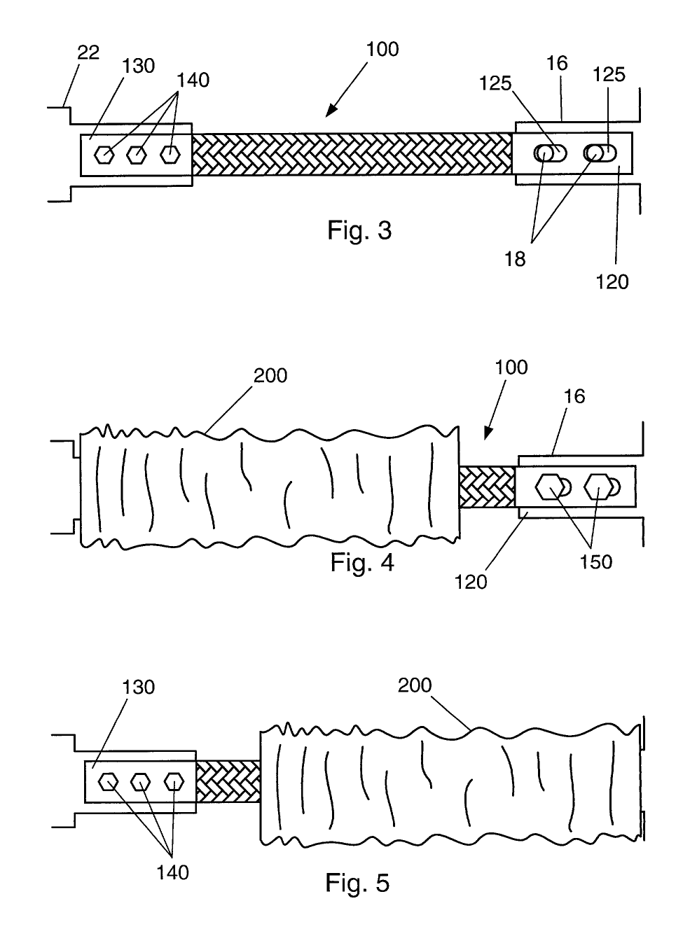

FIG. 2 shows a flexible electrical connector 100 for use in connecting pieces of electrical equipment such as electrical equipment 10, 20, 30. In this example, flexible electrical connector 100 has a flexible portion 110 at the ends of which are connected a first connection end 120 and a second connection end 130. First connection end 120 has some means of connecting to a connection point of a piece of electrical equipment. In the example shown in FIG. 2, first connection end 120 has two elongated slots 125. Second connection end 130 is shown having three holes 135. In this example, first connection end 120 and second connection end 130 are rigid portions made of an electrically conductive material such as, for example, copper or copper plated with silver or tin. Flexible portion 110 provides an electrical connection between first connection end 120 and second connection end 130. Flexible portion 110 is made of a flexible, electrically conductive material such as, for example, copper braid. Other examples of appropriate materials for flexible portion 110 include copper material with a silver or tin plating. By providing flexible electrical connector 100 with flexible portion 110, variations in the originally designed relative position of two pieces of electrical equipment can be overcome without requiring field measurement after the equipment is installed. Adapting to these variations in equipment position is further assisted by slots 125 and first connection end 120. Slots 125 allow first connection end 120 to be positioned in a variety of positions relative to the connection point, for example connection point 16, of the equipment. Although slots 125 are shown in FIGS. 2 and 3 as elongated slots having a height approximately equal to the diameter of the connection holes in the connection point of the equipment, for example, connection holes 18 of connection point 16, it is noted that slots having a different size can also be used. For example, slots 125 can be significantly larger in every dimension than corresponding connection holes in the equipment to allow for additional freedom in positioning first connection end 120 relative to connection point 16.

The structure of the invention permits its use in medium (5 kV-25 kV) and high voltage (>25 kV) applications. Other structures currently being used in low voltage applications often can not withstand medium or high voltage. For example, other structures currently being used in low voltage applications often can not withstand a fault under medium or high voltage conditions.

FIGS. 3-8 show an example of an installation of flexible electrical connector 100. In FIG. 3, second connection end 130 is attached to connection point 22. In this example, second connection end 130 is attached to connection point 22 using three fasteners 140. FIG. 3 shows fasteners 140 as bolts but it is noted that any appropriate fastener can be used. In addition, any appropriate number of fasteners can be used. FIG. 3 shows first connection end 120 positioned relative to connection point 16 such that slots 125 align with connection holes 18. Once it is determined that the alignment of slots 125 with connection holes 18 as shown in FIG. 3 is possible, an insulating sleeve 200 (shown in FIG. 4) is slid over first connection end 120, flexible portion 110 and second connection end 130. FIG. 4 shows insulating sleeve 200 accordioned over flexible portion 110 and second connection end 130 such that first connection end 120 is accessible for connection to connection point 16. At this point, first connection end 120 is repositioned relative to connection point 16 so that slots 125 align with connection holes 18. Fasteners 150 are then used to connect first connection end 120 to connection point 16. In this example, the fasteners 150 are shown as bolts, but any appropriate fasteners can be used. At this point, fasteners 150 are tightened to the appropriate in-use tightness.

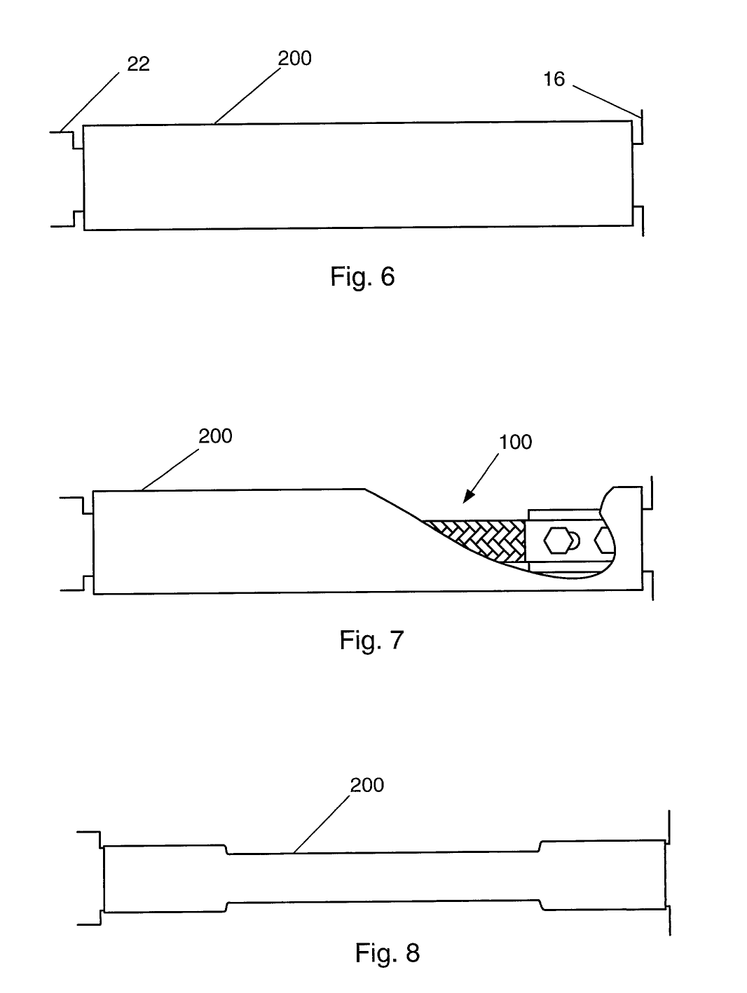

FIG. 5 shows insulating sleeve 200 pushed to the right to expose second connection end 130. At this point, fasteners 140 are tightened to the in-use tightness. After fasteners 140 are appropriately tightened, insulating sleeve 200 is repositioned to cover first connection end 120, flexible portion 110 and second connection end 130. This condition is shown in FIG. 6, which is a side view, and FIG. 7, which is a partial cut-away side view.

After insulating sleeve 200 is correctly positioned to cover first position end 120, flexible portion 110 and second connection end 130, it is fixed in position so that it maintains insulation of first connection end 120, flexible portion 110 and second connection end 130 during use. One example of an appropriate insulating sleeve is a heat-sensitive, electrically insulative tubing. FIG. 8 shows an example of such tubing after being subjected to sufficient heat to cause insulating sleeve 200 to contract around first connection end 120, flexible portion 100 and second connection end 130.

As can be seen from the figures and above description, the invention provides a connection apparatus and method for connecting large electrical equipment in the field without requiring exact field measurements prior to fabricating the connector. The invention also provides sufficient insulation to eliminate or reduce the corona discharge effect to surrounding equipment. In addition, the insulation can be removed and replaced with new insulation should equipment maintenance or servicing require such removal.

While the invention has been described with reference to particular embodiments and examples, those skilled in the art will appreciate that various modifications may be made thereto without significantly departing from the spirit and scope of the invention.

What is claimed is:

1. A flexible electrical connector for connecting a connection point of a first piece of electrical equipment to a connection point of a second piece of electrical equipment, the connector comprising:
a first connection end;
a second connection end;
a flexible portion having first and second ends, the first end being electrically and mechanically connected to the first connection end and the second end being electrically and mechanically connected to the second connection end; and
an insulating sleeve,
wherein when the connector is in use, the insulating sleeve covers the flexible portion and the first and second connection ends,
the first connection end is adapted to connect to the connection point of the first piece of electrical equipment,
the second connection end is adapted to connect to the connection point of the second piece of electrical equipment, and
the second connection end is attachable in a plurality of fixing positions relative to the connection point of the second piece of electrical equipment so as to accommodate a plurality of distances between the first piece of electrical equipment and the second piece of electrical equipment.

2. The connector of claim 1, wherein the second connection end comprises a slot adapted to receive a fastener for connecting the second connection end to the connection point of the second piece of electrical equipment,
wherein the slot is adapted to allow the fastener to occupy a plurality of position within the slot that correspond to the plurality of fixing positions.

3. The connector of claim 2, wherein the insulating sleeve is heatsensitive tubing that contracts when heated.

4. The connector of claim 2, wherein the first connection end is attachable in a plurality of fixing positions relative to the connection point of the first piece of electrical equipment.

5. The connector of claim 2, wherein one of the first piece of electrical equipment and the second piece of electrical equipment is an electrical generator.

6. The connector of claim 5, wherein one of the first piece of electrical equipment and the second piece of electrical equipment is one of a neutral cubical and a switchgear cubical.

7. A method of connecting a connection point of a first piece of electrical equipment to a connection point of a second piece of electrical equipment using a flexible electrical connector, the flexible electrical connector having a flexible portion with first and second ends, a first connection end attached to the first end and a second connection end attached to the second end, the method comprising:
connecting the first connection end to the connection point of the first piece of electrical equipment;
sliding an insulating sleeve over the second connection end, the flexible portion and the first connection end, such that a portion of the second connection end is accessible for connecting to the connection point of the second piece of electrical equipment;
connecting the second connection end to the connection point of the second piece of electrical equipment;
sliding the insulating sleeve over the second connection end, such that the insulating sleeve covers the first connection end, the flexible portion and the second connection end; and
fixing the insulating sleeve so that it covers the first connection end, the flexible portion and the second connection end during use of the flexible electrical connector,
wherein the second connection end is attachable in a plurality of fixing positions relative to the connection point of the second piece of electrical equipment so as to accommodate a plurality of distances between the first piece of electrical equipment and the second piece of electrical equipment.

8. The method of claim 7, wherein the second connection end comprises a slot adapted to receive a fastener that connects the second connection end to the connection point of the second piece of electrical equipment,
wherein the slot is adapted to allow the fastener to occupy a plurality of position within the slot that correspond to the plurality of fixing positions.

9. The method of claim 8, wherein the insulating sleeve is heat sensitive tubing that contracts when heated, and
the insulating sleeve is fixed to the flexible electrical connector by heating the insulating sleeve such that it contracts around and grips the flexible electrical connector.

10. The method of claim 8, wherein the first connection end is attachable in a plurality of fixing positions relative to the connection point of the first piece of electrical equipment.

11. The method of claim 8, wherein one of the first piece of electrical equipment and the second piece of electrical equipment is an electrical generator.

12. The method of claim 11, wherein one of the first piece of electrical equipment and the second piece of electrical equipment is one of a neutral cubical and a switchgear cubical.

13. An electrical equipment assembly, comprising:
a first piece of electrical equipment having an electrical connection point;
a second piece of electrical equipment having an electrical connection point;
a flexible electrical connector for connecting the connection point of the first piece of electrical equipment to the connection point of the second piece of electrical equipment, the connector having
a first connection end;
a second connection end;
a flexible portion having first and second ends, the first end being electrically and mechanically connected to the first connection end and the second end being electrically and mechanically connected to the s second connection end; and
an insulating sleeve,
wherein when the connector is in use, the insulating sleeve covers the flexible portion and the first and second connection ends,
the first connection end is connected to the connection point of the first piece of electrical equipment,
the second connection end is connected to the connection point of the second piece of electrical equipment, and
the second connection end is attachable in a plurality of fixing positions relative to the connection point of the second piece of electrical equipment so as to accommodate a plurality of distances between the first piece of electrical equipment and the second piece of electrical equipment.

14. The assembly of claim 13, wherein the second connection end comprises a slot that receives a fastener that connects the second connection end to the connection point of the second piece of electrical equipment,
wherein the slot allows the fastener to occupy a plurality of position within the slot that correspond to the plurality of fixing positions.

15. The assembly of claim 14, wherein the insulating sleeve is heat-sensitive tubing that contracts when heated.

16. The assembly of claim 14, wherein the first connection end is attachable in a plurality of fixing positions relative to the connection point of the first piece of electrical equipment.

17. The assembly of claim 14, wherein one of the first piece of electrical equipment and the second piece of electrical equipment is an electrical generator.

18. The assembly of claim 17, wherein one of the first piece of electrical equipment and the second piece of electrical equipment is one of a neutral cubical and a switchgear cubical.
